(19) United States
(12) Patent Application Publication
(10) Pub. No.: US 2010/0067406 A1
(43) Pub. Date: Mar. 18, 2010

(54) WIRELESS COMMUNICATION DEVICE, METHOD TO OUTPUT IDENTIFIER, AND COMPUTER USABLE MEDIUM THEREFOR

(75) Inventor: Takanobu SUZUKI, Aichi (JP)

Correspondence Address: Scully, Scott, Murphy &Presser, P.C., 400 Garden City Plaze, Suite 300, Garden City, NY, 11530, US

(73) Assignee: BROTHER KOGYO KABUSHIKI KAISHA, Aichi (JP)

(21) Appl. No.: 12/561,643

(22) Filed: Sep. 17, 2009

(30) Foreign Application Priority Data
Sep. 17, 2008 (JP) 2008-237408

(51) Int. Cl. H04L 12/28

(52) U.S. Cl. 370/254

(57) ABSTRACT

A wireless communication device capable of outputting an identifier of an existing wireless network to an output unit is provided. The wireless communication device includes an identifier obtaining unit to obtain identifiers from a plurality of access points, a judging unit to judge whether each of the access points operates in a specific operation mode based on each of the obtained identifiers, a determining unit to determine an identifier is a first identifier if the access point which provided the identifier does not operate in the specific operation mode, and determine the identifier is a second identifier if the access point which provided the identifier operates in the specific operation mode, and an output control unit to output the first identifier to the output unit, such that the first identifier is shown by the output unit in a manner that the first identifier is distinguished from the second identifier.

### CROSS REFERENCE TO RELATED APPLICATION

This application claims priority from Japanese Patent Application No. 2008-237408, filed on Sep. 17, 2008, the entire subject matter of which is incorporated herein by reference.

### BACKGROUND

1. Technical Field

An aspect of the present invention relates to a wireless communication device to be connected to a network. More specifically, the present invention relates to a technique to output identifiers which identify networks to be recognizable by a user.

2. Related Art

Wireless LAN (local area network) has been widespread and utilized in network computing environment. Hereinafter, a wireless network refers to the wireless LAN. In the network computing environment, a plurality of wireless LANs can be settled in an area. When a communication device is connected to one of the wireless networks, the communication device is required to have predetermined wireless settings installed. For example, when the communication device is selectively connected to one of the plurality of available wireless networks, and predetermined wireless settings are installed in the communication device, a list of SSIDs (service set identifiers) can be created and presented to a user so that the user can select an available wireless network with reference to the list. The SSID is an identifier to identify the wireless network. The list of SSIDs can be created based on signals transmitted from various access points within the networks.

### SUMMARY

When a plurality of wireless networks are available, and a large number of identifiers of the networks such as the SSIDs are detectable by the communication device, however, the user may be troubled by the large numbers of available options, and the user may not find a desirable network identifier easily.

Specifically, whilst the wireless settings can be installed in the communication device automatically, the user can opt to install the wireless communication settings in the device manually. When the user opts to install the wireless communication settings manually, it may be easier for the user to select a preferable wireless network among the number of detected wireless networks if SSIDs identifying wireless networks, of which communication settings can be automatically installed in the device, are eliminated from the SSID list.

In view of the above drawbacks, the present invention is advantageous in that a wireless communication device, in which the network identifiers are presented effectively to the user, is provided. Further, a method to output the identifiers and a computer usable medium therefor are provided.

### BRIEF DESCRIPTION OF THE ACCOMPANYING DRAWINGS

FIG. 1 is a schematic diagram to illustrate a network system according to a first embodiment of the present invention.

FIG. 2 is a block diagram to illustrate the network system with communication devices according to the first embodiment of the present invention.

FIG. 3 is a flowchart to illustrate a first wireless settings installation process according to the first embodiment of the present invention.

FIGS. 4A and 4B are illustrative views of user interfaces to be presented to a user in the wireless settings installation process according to the first embodiment of the present invention.

FIG. 5 is an illustrative view of an SSID list to be presented to the user according to the first embodiment of the present invention.

FIGS. 6A and 6B are illustrative views of an SSID list to be presented to the user in a simple setting mode according to the first embodiment of the present invention.

FIG. 7 is an illustrative view of a search result of the SSIDs according to the first embodiment of the present invention.

FIG. 8 is an illustrative view of a user interface to enter wireless settings according to the first embodiment of the present invention.

FIG. 9 is a flowchart to illustrate a simple installation mode SSID examining process according to the first embodiment of the present invention.

FIG. 10 is a flowchart to illustrate an AOSS examination process according to the first embodiment of the present invention.

FIG. 11 is a flowchart to illustrate a WPS examination process according to the first embodiment of the present invention.

FIG. 12 is a flowchart to illustrate a wireless setting installation process according to a second embodiment of the present invention.

FIG. 13 is an illustrative view of a search result of the SSIDs according to a modified embodiment of the present invention.

FIG. 14 is an illustrative view of a search result of the SSIDs according to an embodiment of the present invention.

### DETAILED DESCRIPTION

Hereinafter, a first embodiment according to an aspect of the present invention will be described with reference to the accompanying drawings.

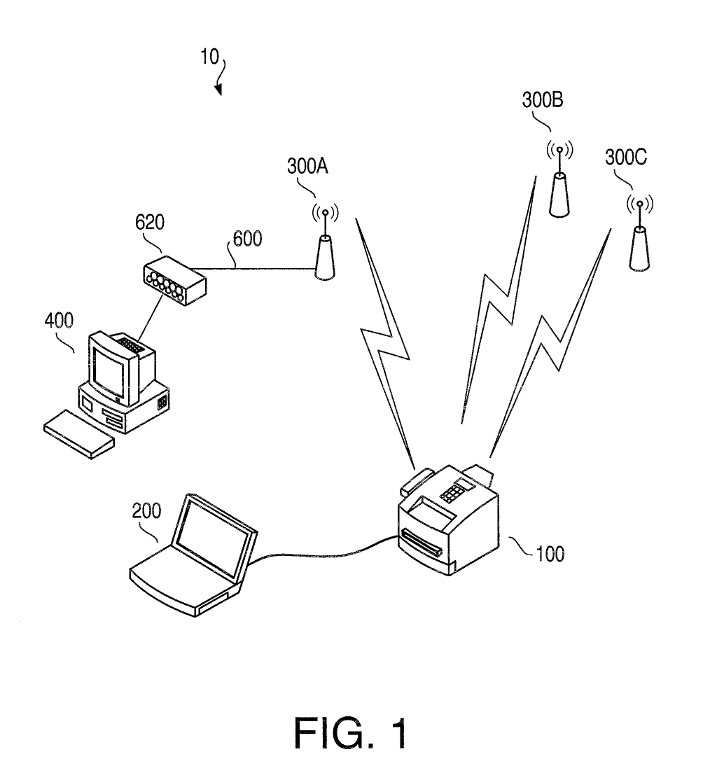

Firstly, an overall configuration of a network system including a wireless network 10 according to the embodiment of the present invention will be described. FIG. 1 is a schematic diagram to illustrate the network system according to the embodiment of the present invention. The wireless network 10 includes an access point 300A and an MFP (multifunction peripheral) 100. The MFP 100 is equipped with a plurality of functions to, for example, print, scan, and/or copy images. The MFP 100 is connected to a PC (personal computer) 400 within the wireless network 10 through the access point 300A, a wired LAN 600, and a hub 620. The MFP 100 can receive print data transmitted from the PC 400 to print and transmits image data representing a scanned image to the PC 400.

The wireless network 10 further has a plurality of access points, including access points 300B and 300C in addition to the access point 300A. In the following description, the access point 300B operates in AOSS (AirStation One-touch Secure Setup) (registered trademark) mode provided by Buffalo Technology, Inc. The access point 300C operates in WPS (Wi-Fi Protected Setup) mode provided by Wi-Fi Alliance. The AOSS and the WPS are known technologies to install wireless settings fully automatically. When wireless settings to connect a wireless communication device to the AOSS-operated access point 300B or to the WPS-operated access point 300C are installed in the wireless communication device, the wireless communication device is also required to run in the AOSS mode or the WPS mode respectively. When the wireless communication device to have the wireless settings installed is not operating in the AOSS or the WPS mode, the wireless settings to connect the wireless communication device to the access point 300B or to the access point 300C are not installable. In the following description, the fully automatic installation of the wireless communication settings in the AOSS mode or the WPS mode will be referred to as “simple installation.”

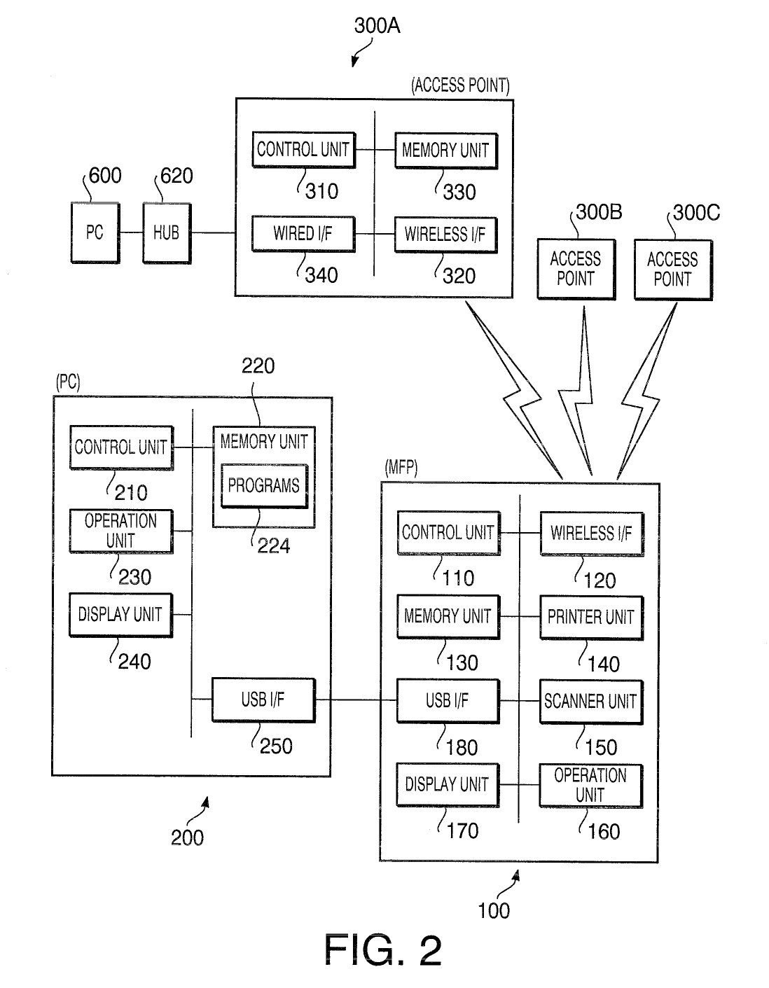

The MFP 100 is further connected with a PC 200 through an USB (universal serial bus) interface (I/F) 180 (see FIG. 2). The PC 200 can process the wireless settings which are to be installed in the MFP 100. The connection between the MFP 100 and the PC 200 is not limited to the USB interfaces 180, 250, but may be achieved through, for example, a wired LAN cable. When the PC 200 is equipped with a wireless interface, for another example, the connection may be achieved through ad-hoc wireless communication.

FIG. 2 is a block diagram to illustrate the network system with communication devices according to the first embodiment of the present invention. According to the present embodiment, the access points 300B, 300C are configured to have same functionalities as the access point 300 and therefore serve similarly to the access point 300A in the network system. Therefore, detailed description and illustration of the access points 300B, 300C are represented by those of the access point 300A. The PC 400 is configured substantially similarly to the PC 200; therefore, description and illustration of the PC 400 are herein omitted. The access points 300B, 300C, and the PC 400 are known access points and a personal computer.

The configuration of the MFP 100 will be described. The MFP 100 includes a control unit 110, a wireless interface (I/F) 120, a memory unit 130, a printer unit 140, a scanner unit 150, an operation unit 160, a display unit 170, and a USB interface 180. The control unit 110 controls behaviors of the MFP 100 itself. The control unit 110 includes, for example, a CPU being an arithmetic processor, a ROM to store various programs to manipulate the MFP 100, and a RAM being a workspace for the processor. When the CPU runs a program stored in the ROM, operations to manipulate the MFP 100 are performed. In this regard, various data, for example, data exchanged with an external device through the wireless interface 120 and entered through an operation unit 160, is stored in the RAM. The stored data is processed by the CPU which accesses the RAM. The CPU develops the programs stored in the ROM in the RAM to run so that the MFP 100 is controlled to provide its functions to the user.

The wireless interface 120 in the MFP 100 is an interface to connect the MFP 100 to, for example, the access point 300A wirelessly in an infrastructure mode. The memory unit 130 is a data storage to store information concerning wireless communication settings of the MFP 100 and may be a non-volatile memory (e.g., an EEPROM) and a hard disk. The printer unit 140 prints an image according to image data, for example, transmitted from the PC 400 or entered through the scanner unit 150. The scanner unit 150 scans an image formed on an original document which is placed on a document holder (not shown). The operation unit 160 provides an interface for data input to a user and includes, for example, input keys such as direction keys, numerical keys, an enter key, and a cancel key. The display unit 170 displays various information concerning operations in the MFP 100. The USB interface (I/F) 180 provides an interface to other USB-enabled devices to be connected with the MFP 100.

The configuration of the PC 200 will be described. The PC 200 is a known personal computer and includes a control unit 210, a memory unit 220, an operation unit 230, a display unit 240, and a USB interface 250. The control unit 210 includes, for example, a CPU, a ROM, and a RAM and controls behaviors of the PC 200 itself. The memory unit 220 is a data storage to store programs 224 which are run to install the wireless settings of the PC 200. The memory unit 220 may be, for example, a hard disk. The CPU in the control unit 210 processes data, which is entered through the USB interface 250 and the operation unit 230, stored in the ROM, and develops the programs 224 stored in the memory unit 220 in the RAM to run, the PC 200 is controlled to provide its functions to the user.

The operation unit 230 provides an input interface to the user entering instructions for running the programs 224 to the PC 200. The operation unit 230 includes, for example, a keyboard and a mouse. The display unit 240 displays information concerning operations performed in the PC 200. The USB interface 250 provides an interface to connect the PC 200 to USB-enabled external devices.

The configuration of the access point 300A will be described. The access point 300A is a known access point and includes a control unit 310, a wireless interface (I/F) 320, a memory unit 330, and a wired interface (I/F) 340. The control unit 310 includes a CPU, a ROM, and a RAM and controls behaviors of the access point 300A. The wireless interface 320 provides an interface to external devices to be wirelessly connected with the access point 300A. Data to be exchanged with the external devices are transmitted and received through the wireless interface 320. The memory unit 330 is a data storage to store information concerning wireless communication settings of the access point 300A. The information to be stored includes an SSID being an identifier to identify the wireless network, a valid authentication method, an encryption method, and a network key. The memory unit 330 may be, for example, an EEPROM. The wired interface 340 is an interface to connect the access point 300A with wired LAN 600.

Hereinafter, processes to install the wireless settings to be connected with the access point 300A in the MFP 100 will be described. Wireless connection between the access point 300A and the MFP 100 is established when the installation processes complete. Thereafter, the MFP 100 is allowed to communicate with the PC 400 to receive, for example, print data transmitted from the PC 400 to print and transmit image data scanned by the scanner unit 150 of the MFP 100 to the PC 400.

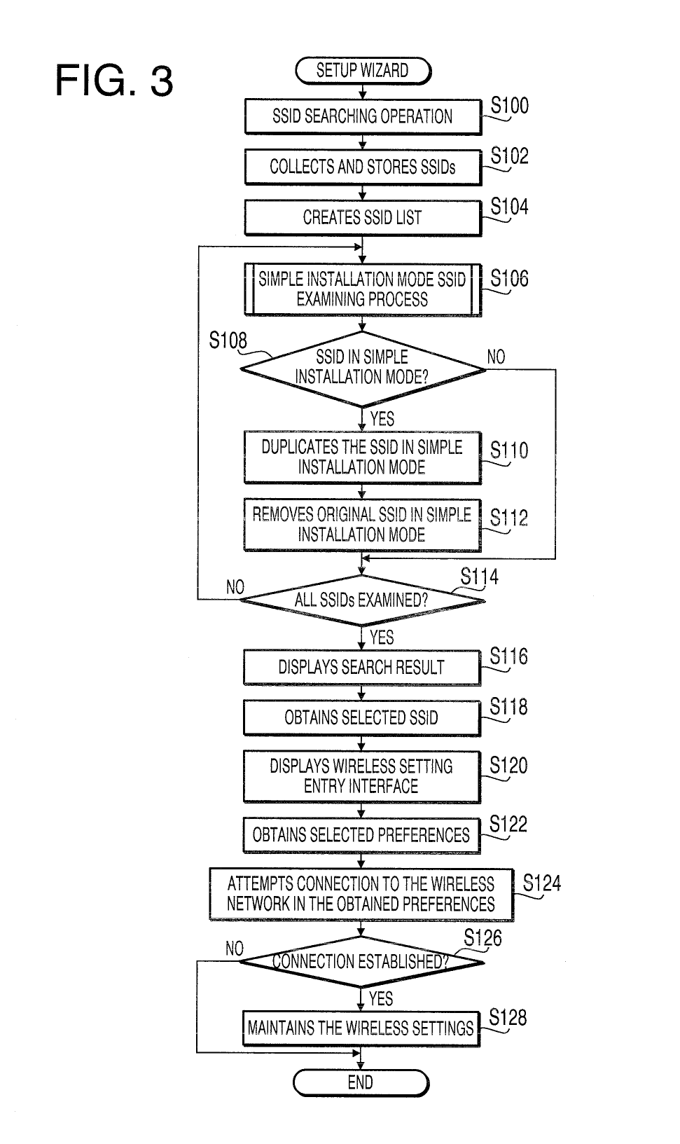

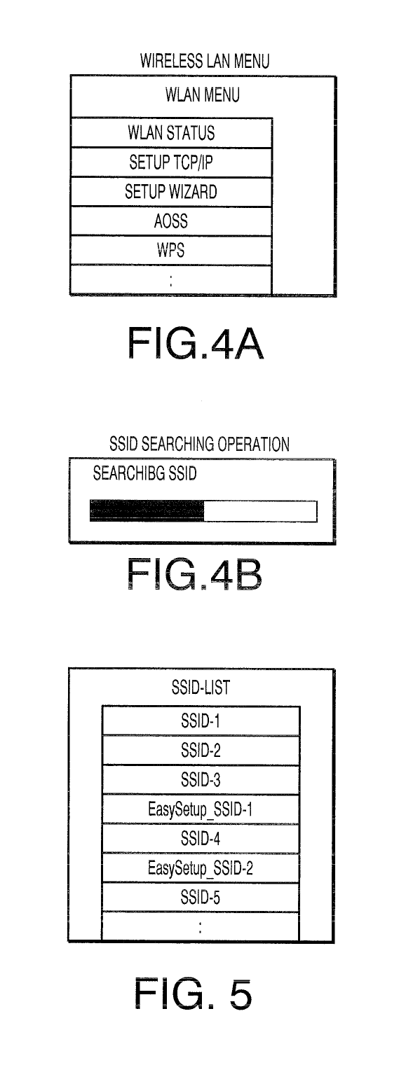

Hereinafter, a first wireless settings installation process will be described with reference to FIG. 3. FIG. 3 is a flowchart to illustrate the first wireless settings installation process according to the embodiment of the present invention. In the present embodiment, the wireless settings are installed in the MFP 100 manually according to the user's preferences. The first wireless settings installation process is activated when the user operates the operation unit 160 to enter an instruction to activate a “SETUP WIZARD” in a wireless LAN menu (FIG. 4A) displayed in the display unit 170. FIG. 4A is an illustrative view of the wireless LAN menu to be presented to the user in the wireless settings installation process according to the first embodiment of the present invention.

According to the present embodiment, when the wireless LAN menu as shown in FIG. 4A is displayed and the user selects “AOSS,” the MFP 100 enters the AOSS mode and installs wireless settings to connect the MFP 100 itself with the AOSS-enabled access point 300B in the MFP 100 itself automatically. When the user selects “WPS,” the MFP 100 enters the WPS mode and installs wireless settings to connect the MFP 100 itself with the WPS-enabled access point 300C in the MFP 100 itself automatically. When the user selects “SETUP WIZARD,” the MFP 100 is prevented from entering the AOSS or the WPS mode, and the wireless settings to connect the MFP 100 itself with the access point 300B or 300C are prevented from being automatically installed.

Behaviors of the control unit 110 of the MFP 100 according to the setup wizard will be described. When the control unit 110 detects the user's input to select “SETUP WIZARD” through the operation unit 160, in S100, the control unit 110 controls the wireless interface 120 and searches for existing access points, including the access points 300A-300C which are provided in the vicinity of the MFP 100 within the wireless networks. The behavior of the control unit 110 to search for the existing access points will be hereinafter referred to as an “SSID searching operation” in the present embodiment. FIG. 4B is an illustrative view of a status bar to be presented to the user during the SSID searching operation of the control unit 110 according to the embodiment of the present invention. When the control unit 110 of the MFP 100 searches for the SSIDs, the access points including the access points 300A-300C generate signals indicating identifiers of the wireless networks to which the access points belong and transmits the generated signals to the MFP 100 in response. In the SSID searching operation, the control unit 110 receives the signals including the SSIDs provided from the access points. In S102, the control unit 110 collects the SSIDs received through the wireless interface 120 and stores the SSIDs in a predetermined area, i.e., an area referred to as an “SSID list area” in the present embodiment, in the RAM. In S104, the control unit 110 creates an SSID list which includes the collected SSIDs.

FIG. 5 is an illustrative view of the SSID list created in S104 and presented to the user according to the first embodiment of the present invention. An SSID “EasySetup_SSID-1” in the SSID list shown in FIG. 5 identifies the wireless network which can be accessed through the access point 300B. An SSID “EasySetup_SSID-2” identifies the wireless network which can be accessed through the access point 300C.

In S106, the control unit 110 picks up one of the SSIDs included in the SSID list and examines as to whether the picked-up SSID is provided from one of the access points which belong to the wireless networks operating in the simple installation modes (i.e., the access points 300B and 300C). Hereinafter, the SSIDs provided from the access points which belong to the wireless networks operating in the simple installation modes will be referred to as “SSIDs in simple installation mode.” The examination in S106 (hereinafter referred to as “simple installation mode SSID examining process”) will be described later in detail.

In S108, the control unit 110 judges as to whether the SSID examined in S106 is an SSID in simple installation mode. If the SSID is not an SSID in simple installation mode (S108: NO), the flow proceeds to S114. If the SSID is an SSID in simple installation mode (S108: YES), in S110, the control unit 110 duplicates the examined SSID and stores the duplicated SSID in a storage area different from the SSID list area. In S112, the control unit 110 removes the original SSID in simple installation mode from the SSID list. In S114, the control unit 110 judges as to whether all the SSIDs included in the SSID list have been examined. If at least one SSID remains unexamined (S114: NO), the control unit 110 returns to S106 and examines the remaining SSID and repeats S106-S114.

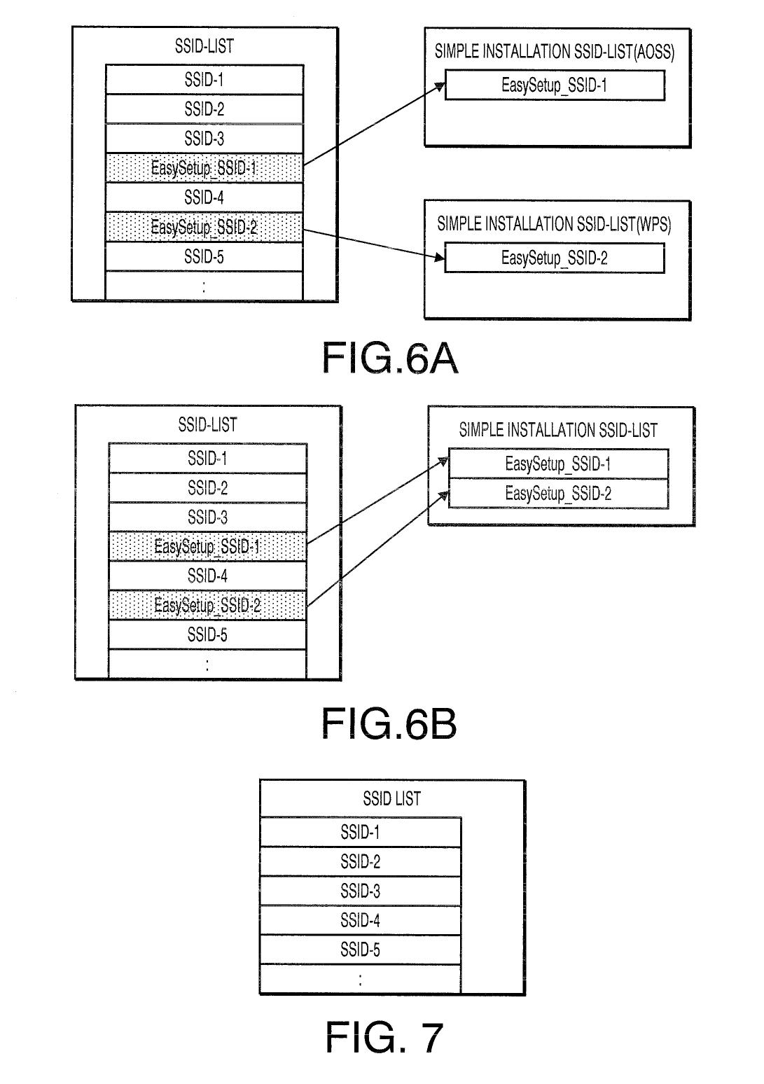

FIG. 6A is an illustrative view of the duplicating process of the control unit 110 in S110 according to the embodiment of the present invention. In S110, the SSID “EasySetup_SSID-1” being an SSID in simple installation mode, which was provided from the access point 300B operating in the AOSS mode, is duplicated, and the duplication is included in a predetermined list “simple installation SSID list (AOSS)” in a predetermined area, “simple installation SSID list area (AOSS).” The SSID “EasySetup_SSID-2” being an SSID in simple installation mode, which was provided from the access point 300C operating in the WPS mode, is duplicated, and the duplication is included in a predetermined list, a “simple installation SSID list (WPS) in a predetermined area, a “simple installation SSID area (WPS).” After the duplicated SSIDs are stored in the predetermined areas, the original SSIDs “EasySetup_SSID-1” and “EasySetup_SSID-2” are removed from the SSID list in S112. The duplicated SSIDs may not necessarily be included in separated lists, but may be included in a single list, such as shown in FIG. 6B. FIG. 6A is an illustrative view of the single simple installation SSID list.

In S116, the control unit 110 presents a search result, i.e., the SSIDs included in the SSID list processed through S106-S112 in the display unit 170. FIG. 7 is an illustrative view of the search result displayed in the display unit 170 according to the embodiment of the present invention. It is to be noted that the “EasySetup_SSID-1” and “EasySetup_SSID-2,” which are the SSIDs provided by the access points 300B and 300C respectively, are not included in the search result. Thus, the access points which do not operate in the simple installation modes are presented separately to be distinguished from the access points which operate in the simple installation modes. The SSID list shown in FIG. 7 indicates the SSIDs provided by the access points which are not operating in the simple installation mode. While the SSID list is displayed in the display unit 170, the user can select one of the SSIDs identifying available wireless networks in the list. The control unit 110 waits until the user selects one of the SSIDs indicated in the SSID list.

When the user's selection is entered through the operation unit 160, in S118, the control unit 110 obtains the selected SSID, and in S120, the control unit 110 displays a user interface window for entering wireless settings in the display unit 170. The user interface window for entering wireless settings will be referred to as a “wireless settings entry window.”

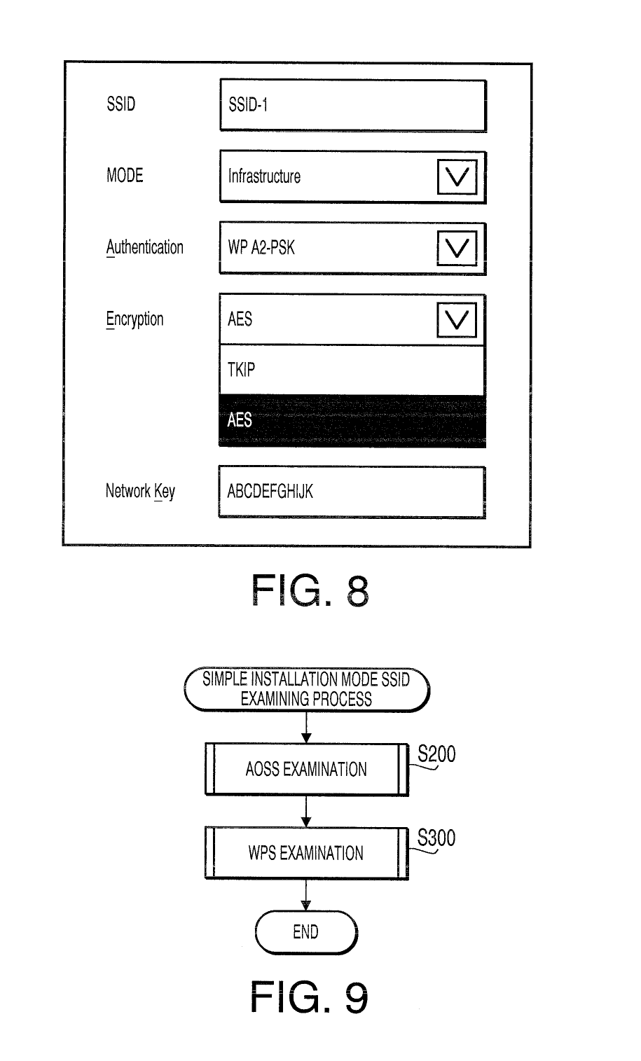

FIG. 8 is an illustrative view of the wireless settings entry window according to the embodiment of the present invention. The wireless settings entry window presents setting options concerning wireless communication modes (Mode), authentication methods (Authentication), encryption methods (Encryption), and a network key (Network Key) to the user. An entry field for SSID is filled with the SSID obtained in S118 by default. An arbitrary character string to be a network key can be entered through the operation unit 160 in the network key field. The wireless communication mode can be selected between two options; infrastructure mode and ad-hoc mode. When the MFP 100 is to be connected to an access point in a wireless network, the infrastructure mode is employed. The authentication method can be selected, for example, among options; open, shared key, WPA-PSK, and WPA2-PSK. The encryption mode can be selected, for example, among options; no encryption, WEP, TKIP, and AES. In FIG. 8, options TKIP and AES are shown. Selection of the methods can be made through a pull-down menu displayed in the display unit 170 according to the user's operation to the operation unit 160.

When the user enters preferences of the wireless communication settings through the wireless settings entry window shown in FIG. 8, in S122, the control unit 110 obtains data corresponding to the entered preferences. In S124, the control unit 110 attempts to establish connection to the wireless network (i.e., the access point 300A) identified by the SSID obtained in S118. In S126, when the attempt to establish the connection fails (S126: NO), the control unit 110 indicates the failure (e.g., displays an error message in the display unit 170) to the user and terminates the process. When the connection is established (S126: YES), in S128, the control unit 110 stores and maintains the wireless settings employed in the establishment in the memory unit 130. The first wireless settings installation process according to the setup wizard is terminated thereafter.

In the above wireless settings installation process, specifically in S116, the result of the SSID searching operation is displayed in the display unit 170. Alternatively or additionally, the search result may be presented to the user in a printed format, which is printed by the printer unit 140. In this configuration, the user can have the search result of the SSID searching operation printed to view specifically when the preferences for the wireless settings are entered in S120. Alternatively or additionally, the search result may be displayed in an externally connected monitor.

The simple installation mode SSID examining process to be executed in S106 will be described. FIG. 9 is a flowchart to illustrate the simple installation mode SSID examining process according to the embodiment of the present invention. When the process starts, in S200, the control unit 110 examines the SSID picked up in S106 is an SSID provided by the access point 300B, which operates in the AOSS mode. The process in S200 will be referred to as an “AOSS examination process.” An SSID provided by an access point operating in the AOSS mode will be hereinafter referred to as an “SSID in AOSS mode.”

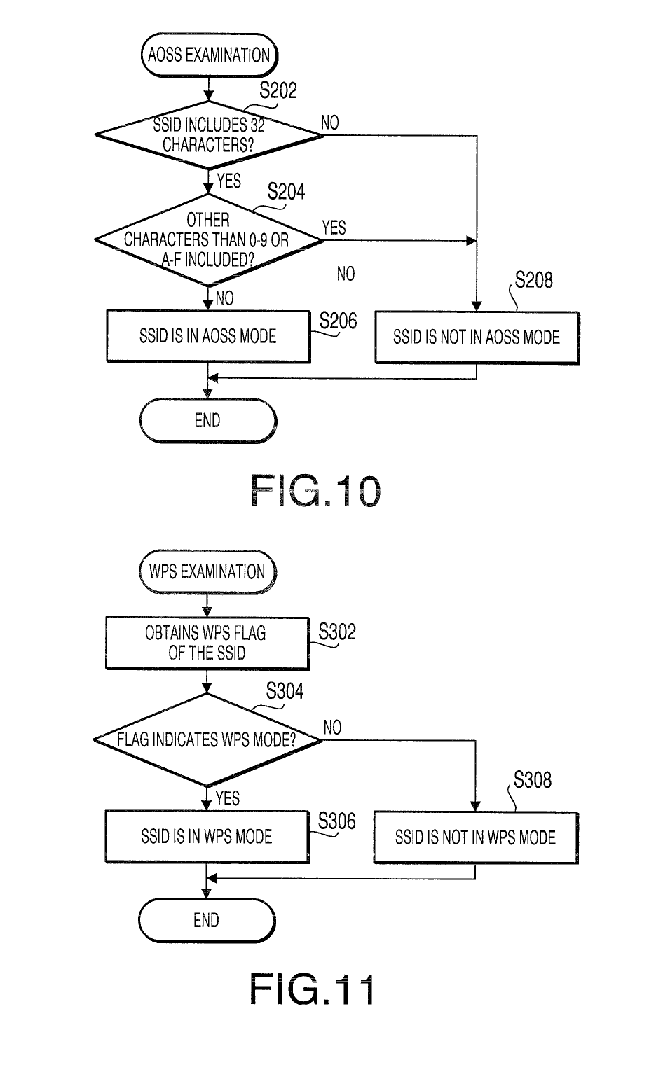

FIG. 10 is a flowchart to illustrate the AOSS examination process according to the embodiment of the present invention. In the present embodiment, judgment as to whether the picked-up SSIDs is an SSID in AOSS mode is made based on a character string included in the SSID. An SSID in AOSS mode generally consists of 32 characters including any of numerals 0, 1, 2, 3, 4, 5, 6, 7, 8, 9 and alphabets A, B, C, D, E, F.

Therefore, in S202, the control unit 110 examines the SSID and judges as to whether the character string in the SSID includes 32 characters. If the character string does not include 32 characters (S202: NO), the flow proceeds to S208. If the character string includes 32 characters (S202: YES), in S204, the control unit 110 judges as to whether the character string includes characters other than 0-9 or A-F. If the character string includes characters other than 0-9 or A-F (S204: YES), the flow proceeds to S208. In S208, the control unit 110 determines that the SSID being examined is not an SSID in AOSS mode and terminates the flow. If the character string includes characters any of 0-9 and A-F, and other characters than 0-9 and A-F are not included (S204: NO), in S206, the control unit 110 determines that the SSID being examined is an SSID in AOSS mode. The flow ends thereafter.

In the above flow, S204 may be omitted, and the judgment to determine whether the SSID is an SSID in AOSS mode may be made solely in S202. This single-stepped judgment is based on a tendency that, when an administrator or a user manually provides an SSID to an access point, it is not likely that the administrator opts for a character string with as many as 32 characters. Meanwhile, alphabets A-F may be used more frequently, even four “A's” consistently, when the administrator provides an SSID to the access point. Therefore, the judgment may be made based solely on the number of characters included in the character string of the SSID.

Following the AOSS examination in S200, in S300, the control unit 110 examines the SSID examined through S220 is an SSID provided by the access point 300C, which operates in the WPS mode. The process in S300 will be referred to as a “WPS examination process.” An SSID provided by an access point operating in WPS mode will be hereinafter referred to as an “SSID in WPS mode.”

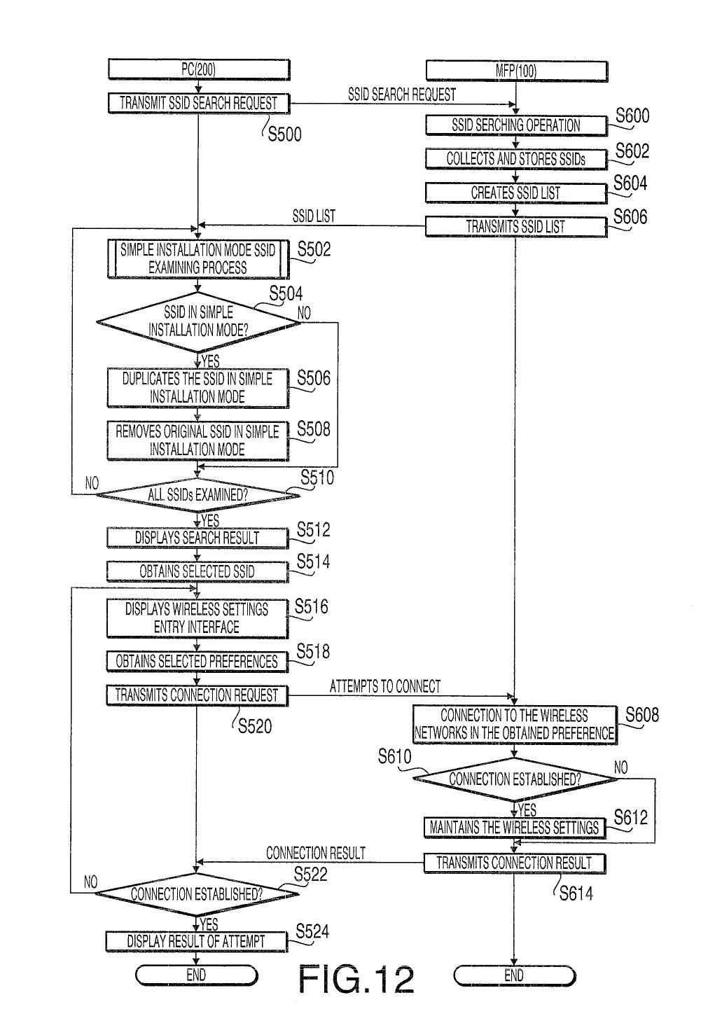

FIG. 11 is a flowchart to illustrate the AOSS examination process according to the embodiment of the present invention. In S302, the control unit 110 obtains additional data, i.e., a WPS flag, which accompanied the SSID when the SSID was provided by the access point during the SSID search operation in S100 (FIG. 3). In S304, the control unit 110 examines the obtained WPS flag and judges as to whether the WPS flag is ON. The WPS flag being ON indicates that the access point which provided the SSID operates in WPS mode. If the WPS flag is ON (S304: YES), in S306, the control unit 110 determines that the SSID being examined is an SSID in WPS mode. If the WPS flag is OFF (S304: NO), in S308, the control unit 110 determines that the SSID being examined is not an SSID in WPS mode. The flow ends thereafter.

In the present embodiment described above, the SSIDs are examined as to whether they are provided from access points in the simple installation wireless communication settings of either the AOSS or the WPS mode. Therefore, in the simple installation mode SSID examining process (FIG. 9), the SSID is examined as to whether it is in the AOSS mode (in S200) or the WPS mode (in S300), and the flow is terminated thereafter. However, other simple installation mode, e.g., SES, may be examined additionally or alternatively in the simple installation mode SSID examination process. Such SES examination process may be added after S300 or replaced with S300 in the simple installation mode SSID examination process. In the SES examination process, when the control unit 110 determines that the SSID being examined is an SSID in SES mode, the SSID in SES mode can be duplicated and the duplication is included in a “simple installation SSID list (SES)” (S110 in FIG. 3). Thereafter, the original SSID can be removed from the SSID list (S112 in FIG. 3).

In the above embodiment, when the user selects a wireless network to connect the MFP 10 and install the wireless settings for the wireless network manually, the SSIDs identifying the wireless networks which operate in the simple (automatic) installation modes are eliminated (S112) from the list of SSIDs detected in the SSID searching operation in S100. Thus, the remaining SSIDs identifying the wireless networks which do not operate in the simple (automatic) installation modes but operate in manual installation modes are presented to the user through the display unit 170 (S116). Therefore, a number of options of the wireless network to connect the MFP 10 is reduced so that the user can more easily select a desirable wireless network to connect the MFP 10 among the reduced number of options.

Next, a second embodiment of the present invention will be described with reference to FIGS. 12-14.

FIG. 12 is a flowchart to illustrate a second wireless setting installation process according to the second embodiment of the present invention. In the present embodiment, the user's instructions to install the wireless settings in the MFP 100 is entered through the PC 200 which is connected to the MFP 100 through the USB interfaces 180, 250 (see FIGS. 1 and 2).

When the second wireless settings installation process starts, i.e., when the control unit 210 of the PC 200 detects the user's instruction to start the second wireless settings installation process through the operation unit 230, in S500, the control unit 210 activates a program 224 stored in the memory unit 220. Further, the control unit 210 controls the USB interface 250 to transmit an SSID search request to the MFP 100 so that the MFP 100 activates an SSID searching operation (S600). During the SSID searching operation, the status bar (see FIG. 4B) indicating that the MFP 100 is in progress to obtain the SSIDs is displayed in the display unit 240 of the PC 200. Thereafter, the MFP 100 processes S600-604, which are similar to S100-S104 shown in FIG. 3. Following S604, in S605, the control unit 110 of the MFP 100 transmits the SSID list (see FIG. 5) to the PC 200 through the USB interface 180.

The control unit 210 of the PC 200 receiving the SSID list performs S502-S518, which correspond to S106-S122 in FIG. 3, and transmits a connection request to the MFP 100 in S520. The connection request transmitted to the MFP 100 contains information of the preferences obtained in S518.

The control unit 110 of the MFP 100, in S608, attempts to establish connection to the wireless network (i.e., the access point 300A in the present and preceding embodiments) identified by the SSID in the information transmitted from the PC 200 in S520. Thereafter, the control unit 110 performs S610 and S612, which correspond to S126 and S128 respectively in FIG. 3. Following S612, the control unit 110 transmits a result of the attempt to the PC 200 through the USB interface 180.

The control unit 210 of the PC 200 receiving the result of the attempt of the MFP 100 judges, in S522, as to whether the attempt succeeded based on the result. When the attempt to establish the connection failed (S522: NO), the flow returns to S516 and repeats S516 to display the wireless settings entry window (see FIG. 8). In this regard, the wireless settings entry window may be accompanied by a message indicating the failure of the attempt for connection. When the connection is established (S522: YES), in S524, the control unit 210 displays a message indicating the establishment of the connection in the display unit 240. The flow terminates thereafter.

According to the above embodiment, a number of options of the wireless network to connect the MFP 10 is reduced so that the user can more easily select a desirable wireless network to connect the MFP 10 among the reduced number of options. Further, the user's input, such as selection of the SSID in S514 and inputting the preferences of the wireless settings in S516, is entered through the operation unit 230 of the PC 200, which has more improved operability than the operation unit 160 of the MFP 100. Moreover, the wireless settings entry window (S516), the SSID list created in S604, and the result of the attempt to establish the connection between the MFP 100 and the access point 300A are displayed in the display unit 240 of the PC 200, which has more improved presentability. Therefore, the user can more easily recognize the operations performed in the PC 200 and the MFP 100.

In the above embodiments, when the search result (i.e., the SSID list) is displayed in S116 and S512, the SSIDS “EasySetup_SSID-1” and the “EasySetup_SSID-2” removed from the SSID list are not displayed in the search result (see FIG. 7). However, the search result may be displayed in different appearances.

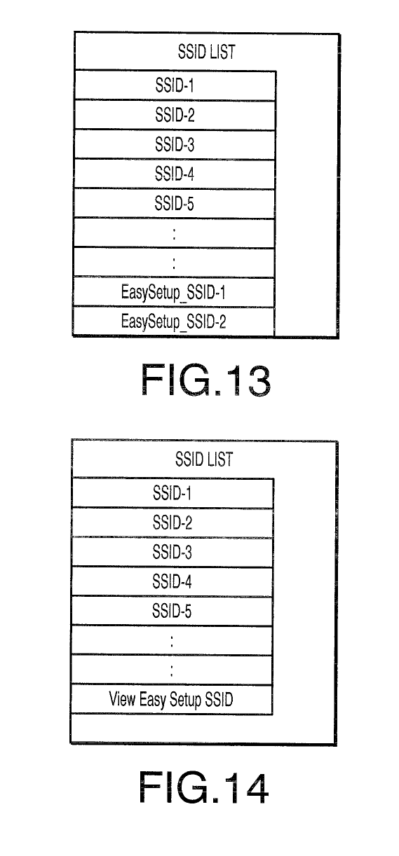

For example, the SSIDs in the simple installation modes detected by the SSID searching operation may be displayed in lower-prioritized positions in the SSID list. FIG. 13 is an illustrative view of the search result of the SSIDs according to a modified embodiment of the present invention. In FIG. 13, the “EasySetup_SSID-1” and the “EasySetup_SSID-2,” which are the SSIDs provided from the access points 300B and 300C operating in the AOSS mode and the WPS mode respectively, are displayed in a bottom portion of the SSID list being displayed. Meanwhile, the other SSIDs, which are not provided from the access points operating in the simple installation modes, are displayed in a top portion of the SSID list so that the user can recognize the SSIDs, which are available for manual setting of the wireless communication, effectively. In this appearance, the user can recognize a total number of wireless networks provided in the vicinity of the MFP 100.

When the “EasySetup_SSID-1” and the “EasySetup_SSID-2,” which are the SSIDs provided from the access points 300B and 300C operating in the AOSS mode and the WPS mode respectively, are not removed from but displayed in the SSID list, it is preferable that these SSIDs are displayed but not capable of being selected by the user. Therefore, the user can be prevented from selecting an inappropriate SSID, of which communication settings are not suitable for manual settings. Further, the SSIDs in simple installation modes may be hidden or displayed according to the user's operation through the operation unit 160. In such a configuration, the user can achieve the advantages of the unsuitable SSIDs being displayed and hidden.

FIG. 14 is another illustrative view of the search result of the SSIDs according to a modified embodiment of the present invention. Specifically, the SSID list being displayed includes indication “View Easy Setup SSID,” which refers to that there are the SSIDs in simple installation modes hidden. When the user enters an instruction to display the hidden SSIDs (e.g., pressing the indication “View Easy Setup SSID” through the operation unit 160), the hidden SSIDs can be displayed. In this configuration, the SSIDs in simple installation mode are presented but not selectable.

When the search result is output in a printed matter, the SSID list shown in FIG. 13 or FIG. 14 can appear on the printed sheet.

What is claimed is:

1. A wireless communication device, to be wirelessly connected to a wireless network through an access point, capable of outputting an identifier of an existing wireless network to an output unit, comprising:
an identifier obtaining unit to obtain identifiers that are detected from signals transmitted from a plurality of access points;
a judging unit to judge whether each of the plurality of access points operates in a specific operation mode or not, based on each of the obtained identifiers;
a determining unit to determine an identifier is a first identifier if the judging unit judges that the access point which provided the identifier does not operate in the specific operation mode, and determine the identifier is a second identifier if the judging unit judges that the access point which provided the identifier operates in the specific operation mode; and
an output control unit to output the first identifier to the output unit, such that the first identifier is shown by the output unit in a manner that the first identifier is distinguished from the second identifier.

2. The wireless communication device according to claim 1,
wherein the output control unit does not output the second identifier to the output unit.

3. The wireless communication device according to claim 2, further comprising:
an instruction receiver to receive a restricting instruction to restrict the second identifier from being outputted and a permitting instruction to permit the second identifier to be outputted through the output unit,
wherein the output control unit does not output the second identifier when the instruction receiver receives the restricting instruction, and the output control unit outputs the second identifier when the instruction receiver receives the permitting instruction.

4. The wireless communication device according to claim 1,
wherein the output control unit outputs the first and second identifiers to the output unit such that the first identifier is presented preferentially over the second identifier.

5. The wireless communication device according to claim 1,
wherein the output control unit outputs the first and second identifiers to the output unit such that the first identifier is presented to be selectable by a user and the second identifier is presented to be not selectable to the user.

6. The wireless communication device according to claim 1,
wherein the judging unit judges whether each of the plurality of access points operates in the specific operation mode or not, based on a total number of characters in a character string constituting the identifier.

7. The wireless communication device according to claim 6,
wherein the judging unit judges whether each of the plurality of access points operates in the specific operation mode or not, based on types of the characters used in the character string constituting the identifier.

8. The wireless communication device according to claim 1,
wherein the judging unit judges whether each of the plurality of access pints operates in the specific operation mode or not, based on flag information is included or not in the signal transmitted from each of the plurality of access points.

9. The wireless communication device according to claim 1, further comprising:
a selection obtaining unit to obtain a selected identifier that is selected by a user from among one or more identifiers presented by the output unit; and
a connection establishing unit to connect the wireless communication device to the existing wireless network identified by the selected identifier.

10. A method to output an identifier of an existing wireless network composed of a plurality of access points through an output device, comprising steps of:
obtaining identifiers that are detected from signals transmitted from the plurality of access points;
judging whether each of the plurality of access points operates in a specific operation mode or not, based on each of the obtained identifiers;
determining an identifier is a first identifier if it is judged that the access point which provided the identifier does not operate in the specific operation mode in the step of judging, and determine the identifier is a second identifier if it is judged that the access point which provided the identifier operates in the specific operation mode in the step of judging; and
outputting the first identifier to the output device, such that the first identifier is shown by the output device in a manner that the first identifier is distinguished from the second identifier.

11. A computer usable medium comprising computer readable instructions for outputting an identifier of an existing wireless network composed of a plurality of access points through an output device, by manipulating a computer to execute steps of:
obtaining identifiers that are detected from signals transmitted from the plurality of access points;
judging whether each of the plurality of access points operates in a specific operation mode or not, based on each of the obtained identifiers;
determining an identifier is a first identifier if it is judged that the access point which provided the identifier does not operate in the specific operation mode in the step of judging, and determine the identifier is a second identifier if it is judged that the access point which provided the identifier operates in the specific operation mode in the step of judging; and
outputting the first identifier to the output device, such that the first identifier is shown by the output device in a manner that the first identifier is distinguished from the second identifier.
